(19) United States
(12) Patent Application Publication
(10) Pub. No.: US 2026/0105353 A1
(43) Pub. Date: Apr. 16, 2026

(54) SEASONALITY-ENHANCED FEDERATED LEARNING FOR STORAGE MANAGEMENT

(71) Applicant: Hewlett Packard Enterprise Development LP, Spring, TX (US)

(72) Inventors: Dejan Milojicic, Palo Alto, CA (US); Alex Veprinsky, San Ramon, CA (US); Pavana Prakash, San Jose, CA (US); Eitan Frachtenberg, Portland, OR (US)

(21) Appl. No.: 18/914,747

(22) Filed: Oct. 14, 2024

(51) Int. Cl. G06N 20/00

(52) U.S. Cl. CPC G06N 20/00

(57) ABSTRACT

In certain examples, a method includes obtaining request metadata, corresponding to requests received at a storage device, to generate a local training dataset; performing training of a local ML model at the storage device for predicting future data accesses and classifying data to be stored in storage types accessible by the storage device; sharing local ML model updates; obtaining a global ML model that incorporates the local ML model updates and ML model updates from other storage devices; performing additional training using the global ML model until the global ML model converges as a trained global ML model; executing the trained global ML model at the storage device to determine storage types in which to store data units and to predict future data requests; and storing a data unit in one or more of the storage types based on an output of the trained global ML model.

### BACKGROUND

Data is often stored in storage mediums of various types. Such storage mediums may be operatively connected to storage devices, which provide access to the data stored in the storage mediums to other computing devices. Storage mediums may have differing characteristics, such as, for example, data access speeds, cost, and the like. Thus, storing data in different types of storage mediums may result in different results, expense, and the like.

### BRIEF DESCRIPTION OF THE DRAWINGS

Certain examples discussed herein will be described with reference to the accompanying drawings listed below. However, the accompanying drawings illustrate only certain aspects or implementations of examples described herein by way of example, and are not meant to limit the scope of the claims. Aspects of the present disclosure are best understood from the following detailed description when read with the accompanying figures. For a more complete understanding of this disclosure, and advantages thereof, reference is now made to the following descriptions taken in conjunction with the accompanying drawings, in which:

FIG. 1 is a block diagram of an example data storage environment, in accordance with to one or more examples disclosed herein.

FIG. 2 is a block diagram of an example request metadata data structure, in accordance with to one or more examples disclosed herein.

FIG. 3 illustrates an overview of an example method for performing federated learning for training of a machine learning (ML) model for data storage, in accordance with to one or more examples disclosed herein.

FIG. 4 illustrates an overview of an example method for using a trained federated learning ML model for data storage, in accordance with to one or more examples disclosed herein.

FIG. 5 illustrates a block diagram of a computing device, in accordance with one or more examples disclosed herein.

The figures are drawn to illustrate various aspects of the disclosure and are not necessarily drawn to scale.

### DESCRIPTION

The following disclosure provides many different examples for implementing different features. Specific examples of components and arrangements are described below to simplify the present disclosure. These are, of course, merely examples and are not intended to be limiting.

Storage architectures may exist in which any number of host computing devices make requests related to data (e.g., read, update, and the like) to any number of storage devices. Each storage device may correspond to or otherwise be configured to access storage back-end components. Storage back-end components may be of various types, each having differing characteristics. As an example, a set of storage components, accessible to host computing devices via any number of storage devices, may include a first storage component type that is relatively faster (e.g., capable of providing data access with less latency), but more expensive (e.g., flash storage), a second storage component type that is relatively slower, but less expensive (e.g., certain hard disk drive storage), and a third storage type that has a speed and cost that each fall between the speeds and costs associated with the first and second storage types.

In such storage architectures, it is often useful to store data in the different types of storage components in such a way as to achieve one or more objectives. Such objectives may include, but are not limited to, reducing or minimizing overall latency of data requests, reducing or minimizing the cost of storing the data in the various storage types, reducing carbon emissions due to storing data in the various storage types and accessing the data from the same, meeting service level objectives, and/or any other objectives relevant to data storage and access of such data.

In order to effectively meet such objectives, examples disclosed herein may use machine learning (ML) models to predict future data accesses (e.g., of data blocks, data objects, data files, and the like), and use the predicted accesses and other information to perform inference or classification that indicates where data should be stored to best meet whatever set of objectives are relevant for a given scenario. Such an ML model may, for example, be a transformer model, a recurrent neural network, and the like.

In one or more examples, the ML may be implemented as federated learning, in which training data is collected locally at each storage device of a set of storage devices, a local ML model is trained using the local data, and local ML model updates (not the actual local data) are shared and aggregated to generate a global ML model, which may be shared with (or generated by) the storage devices participating in the federated learning. The global ML model may then be used to perform the prediction and classification that predicts when data may be accessed, determines where data should be stored (e.g., in what type of storage), and/or helps determine if or when data should be moved (e.g., prefetched, evicted) between storage types. In one or more examples, using federated ML model techniques with a number of storage devices participated in the federated learning may improve resiliency of the global ML model, as the training and execution (e.g., classification, inference) of the global ML model may still operate as intended, even when one or more of the participating storage devices are temporarily or otherwise missing (e.g., offline).

In one or more examples, each storage device receives requests for data over time from each of any number of host computing devices that send requests related to the data (e.g., read, update, delete, and the like). In one or more examples, these requests are used to derive metadata about the requests, which may be stored in a suitable data structure (e.g., an array, a table, and the like). As an example, the metadata may include, for each request, the data unit (e.g., block, file, object, and the like) of the request, the type of request (e.g., insert, retrieve, update, delete, and the like), information identifying the host computing device from which the request was received, and other relevant information (e.g., timestamp for request, relationships between request and other requests, and the like). Such metadata may be collected for any configured amount of time (e.g., minutes, hours, days, weeks, and the like) or other metric (e.g., quantity of requests). In one or more examples, this set of metadata related to incoming requests is used, at least in part, to form a local data set for training a local ML model.

Training the local model may include using the request metadata to train the local ML model to predict when data units will be accessed in the future. As an example, certain data may be accessed by certain hosts at certain times and/or pursuant to certain access patterns (e.g., during certain times of day on certain days during certain parts of certain months). As another example, access of a given data unit may relate to access of certain other data units that may occur when a particular data unit is accessed. Any other patterns of data access or relationships between requested data exhibited by data access requests by host computing devices may be relevant without departing from the scope of examples disclosed herein. In one or more examples, the local ML model on each storage device is trained, at least in part using the request metadata, to predict future data requests, to determine what type of storage medium in a storage back-end in which to store data units, and/or when to move (e.g., pre-fetch, evict) data units between different storage types.

In one or more examples, the predictions of future accesses of data units may be used in conjunction with other considerations to classify data units as appropriate for storage in one or more of the storage types available to a storage device. As an example, predicted future accesses, monetary cost, carbon emission impact, performance requirements, and the like may all be factors used to classify where data should be stored and/or whether certain data units should be moved between storage types.

In one or more examples, once a local ML model is trained on a particular storage device, model updates (e.g., weights, gradients, and the like) may be shared so that model updates from locally trained ML models of any number of storage devices configured to participate in federated learning may be aggregated to generate a global ML model. In one or more examples, each storage device shares its model updates with all other storage devices participating in the federated learning, and each storage device aggregates received model updates with its own model updates to generate the global ML model. Alternatively, in one or more examples, a separate device may be configured to receive model updates from the storage devices participating in the federated learning, and to aggregate the model updates to generate the global ML model, which may then be re-distributed to the storage devices participating in the federated learning. Other techniques for aggregating the model updates to generate a global ML model may be used without departing from the scope of examples disclosed herein (e.g., a hierarchy of storage devices sending model updates that are iteratively updated into higher layer ML models until a final global ML model is generated and redistributed to the storage devices).

In one or more examples, regardless of the technique used to aggregate model updates to generate the global ML model, each storage device ultimately obtains the global ML model, which may then be further trained until the global ML model converges (e.g., stops improving and/or reaches an acceptable performance threshold). The above-described training process may be iterative, both at the local and/or global level, and thus performed until each storage device participating in the federated learning has the converged global ML model.

The trained global ML model may then be used by each of the storage devices to determine, at least in part, where data should be stored to best meet whatever set of objectives are relevant to the data storage scenario in which the storage devices exist and/or predict when requests for data items may be received (which may, for example, cause movement of data between storage types). In one or more examples, determining what type of storage in which to store data units may then cause data to be stored in the various types of storage at various times, which may include movement of data between the different storage types via data prefetching and/or eviction of data from one storage type to another storage type. As an example, based on temporal data access patterns, monetary cost objectives, and carbon emission objectives, data may be stored in a slower, less expensive, and lower carbon emission-producing storage type when it is less likely that the data will be accessed, and the data may be moved to a faster, more expensive, and possibly higher carbon emission producing at times when the data is expected to be accessed in order to meet data access time requirements.

Examples disclosed herein may provide techniques for using federated learning to effectively predict when data requests may be received, store data in various types of storage, and move the data between the types of storage, in order to effectively balance a variety of objectives, which may, for example, improve storage performance, lower costs, reduce carbon emissions, and/or reduce power consumption. Such improvements may be achieved, for example, using local training of ML models on storage devices, performing federated learning via aggregation of local training results to generate a global model, and use of the global model by storage devices to effectively manage where data is stored to optimize data access based on a variety of objectives.

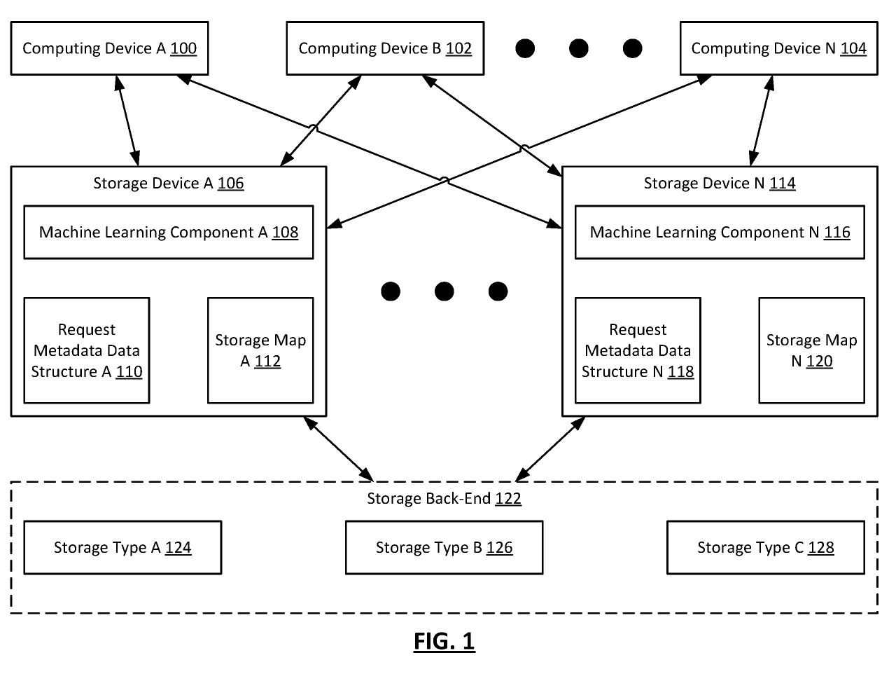

FIG. 1 is a block diagram of an example data storage environment, in accordance with to one or more examples disclosed herein. A data storage environment may include any number of computing devices (e.g., computing device A 100, computing device B 102, computing device N 104), any number of storage devices (storage device A 106, storage device N 114), and a storage back-end 122. Each storage device may include a ML component (e.g., ML component A 108, ML component N 116), a request metadata data structure (e.g., request metadata data structure A 110, request metadata data structure N 118), and a storage map (e.g., storage map A 112, storage map N 120). The storage back-end 122 may include any number of storage types (e.g., storage type A 124, storage type B 126, storage type C 128). Each of these components is described below.

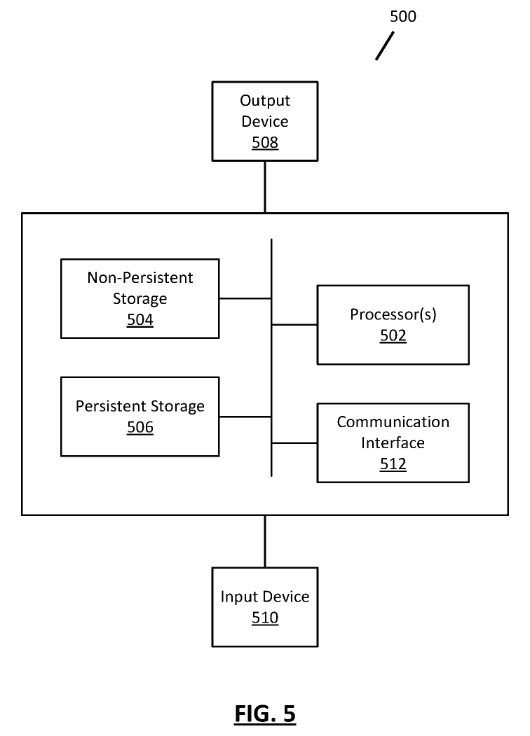

In one or more examples, the data storage environment includes any number of computing devices (e.g., computing device A 100, computing device B 102, computing device N 104). In one or more examples, as used herein, a computing device (e.g., computing device A 100, computing device B 102, computing device N 104) may be any single computing device, a set of computing devices, a portion of one or more computing devices, or any other physical, virtual, and/or logical grouping of computing resources. One example of a computing device is shown in FIG. 5, and described below. In one or more examples, a computing device (e.g., computing device A 100, computing device B 102, computing device N 104), as used herein, may be any computing device of any type that is configured to transmit requests related to data (e.g., read, write, insert, retrieve, update, delete, and the like) to storage devices (e.g., the storage device A 106, the storage device N 114) that include and/or are operatively connected to a storage back-end (e.g., the storage back-end 122) storing the data in one or more storage types (e.g., the storage type A 124, the storage type B 126, the storage type C 128). As an example, a computing device (e.g., computing device A 100, computing device B 102, computing device N 104) seeking to read data may send a read data request to a storage device (discussed further below), which may provide the requested data from a data storage location to the computing device from which the request was received.

In one or more examples, a computing device is any device, portion of a device, or any set of devices capable of electronically processing instructions and may include, but is not limited to, any of the following: one or more processors (e.g. components that include circuitry), memory (e.g., random access memory (RAM)), input and output device(s), non-volatile storage hardware (e.g., solid-state drives (SSDs), persistent memory (Pmem) devices, hard disk drives (HDDs) (not shown)), one or more physical interfaces (e.g., network ports, storage ports), any number of other hardware components (not shown), and/or any combination thereof.

Examples of computing devices include, but are not limited to, a server (e.g., a blade-server in a blade-server chassis, a rack server in a rack, a desktop server, any other type of server device), a desktop computer, a mobile device (e.g., laptop computer, smart phone, personal digital assistant, tablet computer, automobile computing system, and/or any other mobile computing device), a storage device (e.g., a disk drive array, a fibre channel storage device, an Internet Small Computer Systems Interface (iSCSI) storage device, a tape storage device, a flash storage array, a network attached storage device, any other type of storage device), a network device (e.g., switch, router, multi-layer switch, any other type of network device), a virtual machine, a virtualized computing environment, a logical container (e.g., for one or more applications), a container pod, an Internet of Things (IoT) device, an array of nodes of computing resources, a supercomputing device, a data center or any portion thereof, and/or any other type of computing device with the aforementioned requirements. As one of ordinary skill in the art will appreciate, any of the aforementioned examples of computing devices necessarily require at least some hardware components. As an example, a virtual machine, a container, and/or a container pod, when considered as a computing device herein, includes the underlying hardware on which the virtual machine, a container, and/or a container pod executes.

In one or more examples, the storage and/or memory of a computing device or system of computing devices may be and/or include one or more data repositories for storing any number of data structures storing any amount of data (e.g., information). In one or more examples, a data repository is any type of storage unit and/or device (e.g., a file system, database, collection of tables, RAM, hard disk drive, solid state drive, and/or any other storage mechanism or medium) for storing data. Further, the data repository may include multiple different storage units and/or devices. The multiple different storage units and/or devices may or may not be of the same type or located at the same physical location.

In one or more examples, any storage and/or memory of a computing device or system of computing devices may be considered, in whole or in part, as non-transitory computer readable mediums storing software and/or firmware, which, when executed by one or more processors, cause the one or more processors to perform operations (e.g., execution of one or more computer programs) in accordance with one or more examples disclosed herein.

In one or more examples, although FIG. 1 shows an example data storage environment that includes three computing devices (e.g., computing device A 100, computing device B 102, computing device N 104), a data storage environment may include any number of computing devices without departing from the scope of examples disclosed herein.

In one or more examples, each computing device (e.g., computing device A 100, computing device B 102, computing device N 104) of a data storage environment may be operatively connected to any number of storage devices (discussed further below) configured to provide the computing devices access to stored data. In the example data storage environment shown in FIG. 1, each of the computing device A 100, the computing device B 102, and the computing device N 104 are shown as operatively connected to each of the storage devices (e.g., the storage device A 106, the storage device N 114). However, examples disclosed herein are not limited to such a configuration. Any particular computing device may be operatively connected to any number of storage devices (e.g., all or any portion of the storage devices of a data storage environment), and the set of one or more storage devices to which a particular computing device is operatively connected may differ for different computing devices.

In one or more examples, a storage device (e.g., the storage device A 106, the storage device N 114) may be any hardware and/or software, firmware, and the like executing on hardware that is configured to receive and service data requests from one or more computing devices (e.g., the computing device A 100, the computing device B 102, the computing device N 104). As an example, a storage device (e.g., the storage device A 106, the storage device N 114) may be all or any portion of a computing device (discussed above and also below in the description of FIG. 5). In one or more examples, a storage device (e.g., the storage device A 106, the storage device N 114) may be operatively connected to any number of computing devices (e.g., the computing device A 100, the computing device B 102, the computing device N 104), with each computing device being operatively connected to one or more interfaces of the storage device (e.g., the storage device A 106, the storage device N 114). In one or more examples, each storage device (e.g., 108, 114) is configured to receive data requests from one or more operatively connected computing devices, and to service such data requests by accessing one or more storage types (e.g., 124, 126, 128) of a storage back-end (e.g., 122) storing one or more data units corresponding to a received data request (e.g., by retrieving and providing the data, by updating the data, by adding new data, by deleting data, and the like).

Although FIG. 1 shows a data storage environment that includes two storage devices (106, 114), a data storage environment may include any number of storage devices without departing from the scope of examples disclosed herein. Each storage device (e.g., the storage device A 106, the storage device N 114) may be operatively connected to any number of computing devices (e.g., the computing device A 100, the computing device B 102, the computing device N 104). Each storage device may or may not be operatively connected to the same set of computing devices as other storage devices of the data storage environment (e.g., a first storage device may be operatively connected to a first set of computing devices, a second storage device may be operatively connected to a second set of computing devices, and the two sets of computing devices may or may not entirely overlap with one another).

In one or more examples, each storage device (e.g., the storage device A 106, the storage device N 114) of a data storage environment is operatively connected to a storage backend (e.g., the storage back-end 122). In one or more examples, as used herein, a storage back-end (e.g., the storage back-end 122) refers to any collection of devices, components, data repositories, and the like, which may be separate from, and operatively connected to, any number of storage devices (e.g., the storage device A 106, the storage device N 114) and/or, in whole or in part, included in such storage devices. In one or more examples, the storage back-end 122 is configured to store data of any type.

Data may be stored using any technique, scheme, and the like for storing data, such as, for example, block storage techniques (e.g., using non-volatile memory express (NVMe)), file storage techniques (e.g., using network file storage), object-based storage techniques, and the like, or a combination of such techniques. The storage-back-end 122 may, alone or in conjunction with one or more storage devices (e.g., the storage device A 106, the storage device N 114) implement one or more data storage technologies and protocols (e.g., fibre channel, iSCSI, network attached storage, and the like). Any other data storage techniques, technologies, protocols, and the like may be used in the storage back-end 122 without departing from the scope of examples disclosed herein.

In one or more examples, the storage back-end 122 includes any number of different storage types (e.g., the storage type A 124, the storage type B 126, the storage type C 128). In one or more examples, as used herein, a storage type refers to a particular type of storage medium used for storing data. Examples of such storage types include, but are not limited to, hard disk drives, solid state drives, flash memory storage devices, optical storage devices, tape storage devices, removable storage devices, and the like. Other storage types may be used without departing from the scope of examples disclosed herein. In one or more examples, each storage type (e.g., the storage type A 124, the storage type B 126, the storage type C 128) is configured to store data as data units. In one or more examples, as used herein, a data unit may refer to any discrete item of data, such as, for example, a block of data, a data file, a data object, and the like.

In one or more examples, different storage types (e.g., the storage type A 124, the storage type B 126, the storage type C 128) may have different characteristics. As an example, some storage types may provide faster or slower access to data stored therein relative to other storage types. As another example, some storage types may be more or less expensive to store data on than other storage types. As another example, some data types may require more or less power than other storage types, which may, for example, cause relatively more or less carbon emissions when used to store and provide access to data. Storage types may differ with respect to other characteristics without departing from the scope of examples disclosed herein.

In one or more examples, storage types may be considered different tiers of storage based on one or more differing characteristics between the storage types. As an example, a given storage back-end (e.g., the storage back-end 122) may be a fast tier (e.g. the storage type A 124), a slower tier (e.g., the storage type B 126), and a slowest tier (e.g., the storage type C 128), as defined by the data access speeds that the storage types in each tier are capable of providing. Such tiers may also differ with regards to other characteristics. As an example, relatively faster tier storage types may be more expensive, while relatively slower tiers may be relatively less expensive.

As such, determining what storage type (and, correspondingly, what tier) within a storage back-end (e.g., the storage back-end 122) in which to store data units may depend on any number of considerations. Such considerations may include, but are not limited to, providing optimal data access times, managing data storage costs, managing ancillary effects of storing data (e.g., carbon emissions), storage efficiency (e.g., avoiding data fragmentation), meeting defined service level objectives, and the like. In view of such considerations, in one or more examples, data may be moved between different storage types from time to time in order to help balance such considerations and/or achieve one or more goals for the data storage (e.g., balance data access times with expense of data storage). As an example, data that is expected to be accessed in the near future may be pre-fetched from a relatively slower and less expensive storage type to a relatively faster and more expensive data type, and/or data that is less likely to be accessed soon may be evicted from the faster, more expensive storage type to a slower, less expensive data type.

Although FIG. 1 shows a storage back-end 122 as including three storage types (e.g., the storage type A 124, the storage type B 126, the storage type C 128), a storage back-end may include any number of storage types without departing from the scope of examples disclosed herein. Additionally, although FIG. 1 shows each storage device of the data storage environment (e.g., the storage device A 106, the storage device N 114) as being operatively connected to the same storage back-end 122 that includes the three storage types (e.g., the storage type A 124, the storage type B 126, the storage type C 128), examples disclosed herein are not so limited. Each storage device may be operatively connected to, and thus be configured to provide access to all or any portion of the storage types of the storage back-end, and which storage types a storage device is operatively connected to may differ between different storage devices.

As discussed above, a storage device (e.g., the storage device A 106, the storage device N 114) may be configured to receive data requests. In one or more examples, a data request is a request of any type received at a storage device (e.g., the storage device A 106, the storage device N 114) from a computing device (e.g., the computing device A 100, the computing device B 102, the computing device N 104) related to data stored in one or more storage types (e.g., the storage type A 124, the storage type B 126, the storage type C 128) of a storage back-end (e.g., the storage back-end 122).

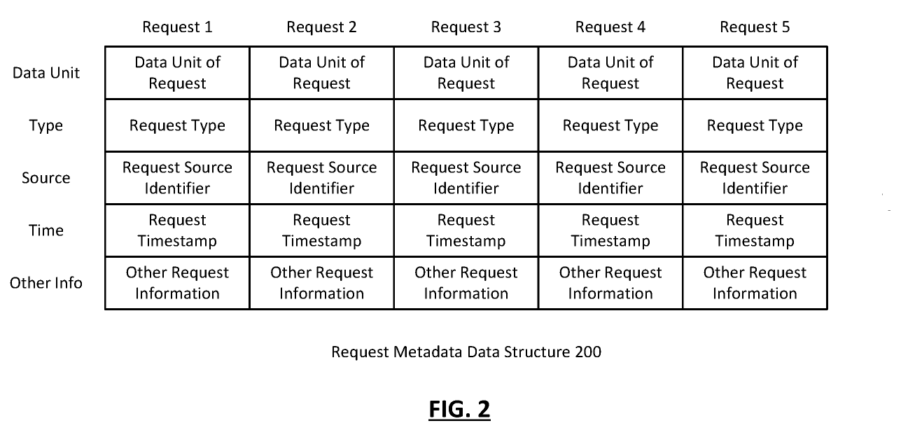

In one or more examples, a data request received at a storage device may be any request for an operation related to one or more data units, including, but not limited to, operations to read data, write data, update data, delete data, move data, and the like. In one or more examples, each storage device (e.g., the storage device A 106, the storage device N 114) is configured to receive such data requests, and to obtain and store metadata related to the data requests in a request metadata data structure (e.g., the metadata data structure A 110 of storage device A 106, the request metadata data structure N 118 of the storage device N 114). Data requests and request metadata data structures are discussed further in the description of FIG. 2, below.

In one or more examples, each storage device includes a storage map (e.g., the storage map 112 of the storage device A 106, the storage map N 120 of the storage device N 114). In one or more examples, a storage map (e.g., 110, 118) is information, maintained by a storage device (e.g., 106, 114), that tracks what data units are stored in each of the storage types (e.g., 124, 126, 128) to which the storage device is operatively connected at a given time. As such, the storage map may be updated as data is moved between storage types, data is added to one or more storage types, data is deleted from one or more storage types, and the like. In one or more examples, a storage map (e.g., 110, 118) is used by a storage device (e.g., 106, 114) to locate data units related to data requests received from computing devices (e.g., 102, 104, 106).

In one or more examples, each storage device includes a ML component (e.g., the ML component 108 of the storage device A 106, the ML component N 116 of the storage device N 114). In one or more examples, a ML component (e.g., 108, 116) is any hardware and/or software executing on hardware components that is configured to perform various activities, operations, communications, and the like to facilitate training and execution of ML algorithms. As an example, a ML component (e.g., 108, 116) may execute using at least a portion of the computing resources of a storage device (e.g., 106, 114).

In one or more examples, all or any portion of the storage devices (e.g., 106, 114) of a data center environment may be configured to participate in federated learning. In one or more examples, federated learning is a technique in which a local ML model is locally trained at devices participating in the federated learning, results of the local training are shared, the shared results are used to generate a global ML model, the global ML model is obtained by the devices participating in the federated learning, and, after one or more training cycles, the trained global ML model is used at the devices participating in the federated learning. In one or more examples, the storage devices (e.g., 106, 114) are configured with a ML component (e.g., 108, 116), which performs the actions, operations, communications, and the like of the various portions of implementing the local and federated learning.

In one or more examples, a ML component (e.g., 108, 116) may be configured to use at least a portion of the request metadata from a request metadata data structure (e.g., 110, 118) as at least a portion of training data for training a local ML model. The ML model may be any form of ML model for, once trained, performing prediction, classification, inference, and the like by being provided input data, and generating results based at least in part on the input data. Examples of such ML models include, but are not limited to, transformer models, recurrent neural networks, and the like.

To perform local training, a ML component (e.g., 108, 106) may be provided with a local ML model. In one or more examples, the ML components (108, 116) are provided with a copy of the same ML model, which may be similarly initialized (e.g., with an initial set of weights, gradients, and the like). The ML component (e.g., 108, 116) may then use request data from the request metadata data structure (e.g., 110, 118) as training data that is used to train the local ML model to make predictions and classifications. In one or more examples, the predictions may include training the local ML model to predict when requests for data units will be received, and the classifications may include training the local ML model to classify the requests as best being serviced by storing data in one or more of the storage types (e.g., faster, less fast, slowest). The ML model may be configured to use any information to make such predictions and classifications, such as timestamps of requests, patterns of request receipts (both in regard to patterns of requests for particular data units and relationships between requests for various data units), and other factors such as cost, carbon emissions, service level objectives, and the like.

In one or more examples, after one or more cycles (e.g., iterations) of training for a local ML model, a ML component (e.g., 108, 116) may be configured to transmit ML model updates (e.g., weights, gradients, and the like obtained via the aforementioned training to minimize a loss function of the ML model). Such ML model updates may be shared so that the ML model updates from each of the ML components (e.g., 108, 116) of the various storage devices (e.g., 106, 114) participating in federated learning may be aggregated to update a global ML model. In one or more examples, each storage device (e.g., 106, 114) shares is local ML model updates with each other storage device participating in the federated learning, and each storage device then aggregates its own model updates with the model updates from the other storage devices to update the global ML model, so that each storage device obtains a copy of the global ML model. In one or more examples, each storage device (e.g., 106, 114) shares its local ML model updates with a separate aggregation device (not shown, which may be referred to as an ML model aggregation device), which is configured to aggregate the local ML model updates from the various storage devices to update the global ML model, which is then redistributed to the storage devices, so that each storage device has a copy of the updated global ML model. In one or more examples, a hierarchical scheme is implemented among the storage devices such that the local ML model updates from portions of the storage devices are used to generate intermediate global models, which are, in turn, aggregated into a final global ML model, which is then redistributed to the storage devices, so that each storage device has a copy of the updated global ML model. In one or more examples, the updated global ML model obtained at each ML component (e.g., 108, 116) may be subjected to additional training at the storage devices, for example, until model convergence is reached (e.g., stops improving and/or reaches an acceptable performance threshold). In one or more examples, the above-discussed aggregation of local ML model training results via sharing of model updates may be performed even when one or more of the storage devices participating in the federated learning is unavailable, which may provide resiliency for the federated ML model.

In one or more examples, once the updated trained global ML model has been obtained by the ML components (e.g., 108, 116) of each of the storage devices (e.g., 106, 114) participating in the federated learning, the ML components may use the trained global ML model to make predictions of when future requests for data units stored in the storage back end (e.g., 122) on one or more storage types (e.g., 124, 126, 128) may be received, and/or to classify where data units should be stored based on when requests related to the data units are expected to be received combined with any number of other factors (e.g., cost, service level objectives, carbon emissions, and the like).

In one or more examples, based at least in part on such predictions and classifications, the storage devices (e.g., 106, 114) may execute algorithms for prefetching data units from storage types to other storage types, and/or evicting data units from certain storage types to other storage data types. Such prefetching and/or evicting of data units may, for example, be determined based at least in part on an effectiveness function of storing data units in storage types of different tiers, and that may take into account hit rates at each tier (e.g., whether data units of a data request are present in a particular storage type), plus other relevant additional cost factors.

While FIG. 1 shows a particular configuration of components, other configurations may be used without departing from the scope of examples described herein. For example, although FIG. 1 shows certain components as part of the same device, any of the components may be grouped in sets of one or more components which may exist and execute as part of any number of separate and operatively connected devices. As another example, a single component may be configured to perform all, or any portion of the functionality performed by the all or any portion of the components shown in FIG. 1. Accordingly, examples disclosed herein should not be limited to the configuration of components shown in FIG. 1.

FIG. 2 is a block diagram of an example request metadata data structure 200, in accordance with to one or more examples disclosed herein. FIG. 2 shows an example in which request metadata is organized in tabular form. However, one of ordinary skill in the art, having the benefit of this disclosure, will appreciate that any form of data structure for organizing request metadata may be used without departing from the scope of examples disclosed herein. The request metadata data structure 200 may, for example, be one example of the request metadata data structure A 110 and/or the request metadata data structure N 118 shown in FIG. 1.

As shown in FIG. 2, the request metadata data structure 200 includes columns corresponding to each data request received at a storage device (e.g., the storage device A 106, the storage device N 114 of FIG. 1). In one or more examples, an entry is added to the request metadata data structure 200 for each received data request. In one or more examples, each entry includes metadata related to the data request.

In one or more examples, the various items of metadata corresponding to a received data request include, as shown in the example of FIG. 2, an identification of the data unit to which the data request pertains. Such an identification may be any form of information for identifying a data unit without departing from the scope of examples disclosed herein. Examples include, but are not limited to, a block identifier, a file name, an object identifier, and the like.

In one or more examples, the various items of metadata corresponding to a received data request include, as shown in the example of FIG. 2, information identifying a request type. In one or more examples, a data request may be any of a number of request types related to the data. Examples of possible request types include, but are not limited to, insertions (e.g., adding data), retrievals (e.g., reading data), updates (e.g., modifying data), and deletions (e.g., removing data), and the like. Other request types may be used without departing from the scope of examples disclosed herein. In one or more examples, such request types may be encoded using an encoding technique that uniquely identifies a request type from among a set of possible request types. As example, an encoding technique such as one-hot encoding, or tokenizer may be used to represent each request type as a binary vector (e.g., insert=[1, 0, 0, 0]; retrieve=[0, 1, 0, 0]; update=[0, 0, 1, 0]; delete=[0, 0, 0, 1]).

In one or more examples, the various items of metadata corresponding to a received data request include, as shown in the example of FIG. 2, information identifying a source of a data request. In one or more examples, the source of a data request is the computing device from which the data request is received. The request source identifier may be any information of any type that uniquely identifies a data request source among a set of possible data request sources. Examples of such types of information include, but are not limited to, an Internet Protocol (IP) address, a serial number, a universally unique identifier (UUID), and the like.

In one or more examples, the various items of metadata corresponding to a received data request include, as shown in the example of FIG. 2, include a request timestamp. In one or more examples, a request timestamp is any item of information that identifies a time at which a data request is received at a storage device. A request timestamp may be information in any form that conveys information about the time a data request was received, including, but not limited to, a time of day, a date, a position of a clock of the storage device, and the like.

In one or more examples, the various items of metadata corresponding to a received data request include, as shown in the example of FIG. 2, other request information. In one or more examples, other request information is any other information related to a received data request. Although FIG. 1 shows a data structure with one entry per data request for other request information, any number of items of other request information may be included as metadata related to a data request without departing from the scope of examples disclosed herein. Other request information is intended to broadly represent that any other metadata related to a data request may be added to the request metadata data structure, and that such information may be obtained from any source and may not necessarily be related to the timing of receipt of the data requests. Examples include, but are not limited to, information relationships between data items (e.g., a request for a particular data unit is often followed by data requests for related data units), real-world events driving data requests (e.g., celebrity actions, the occurrence of notable events, product releases, and the like) and any other type of non-temporally related information that may drive the receipt of requests related to particular data units.

In one or more examples, the request metadata data structure 200 stores metadata related to any number of data requests received at a storage device from one or more operatively connected computing devices. Such request metadata may be stored permanently, or may be deleted pursuant to any form of schedule (e.g., request metadata over a certain age may be deleted). In one or more examples, the request metadata may be used, at least in part, by a ML component (e.g., the ML component A 108, the ML component 116 of FIG. 1) as training data for training local ML models (e.g., to be able to predict when future data requests will be received) and/or for performing additional training on global ML models to achieve model convergence. In one or more examples, the request metadata of the request metadata data structure 200 may also be used on an ongoing basis as at least part of input to a trained global ML model executed by a ML component of a storage device to predict when future requests for data units will be received and/or to classify such requests as to the one or more storage types in which data units of the predicted data requests should be stored.

In one or more examples, a ML component of a storage device may use all or any portion of the data stored in the request metadata data structure 200. As an example, a ML component may implement a configurable context window that limits the request metadata used for training an ML model to a certain number of requests, to only requests received within a particular window of time, and the like. Being configurable, such a context window may be adjusted as needed based on, for example, the dataset formed by the request metadata, performance requirements for the ML model, and the like.

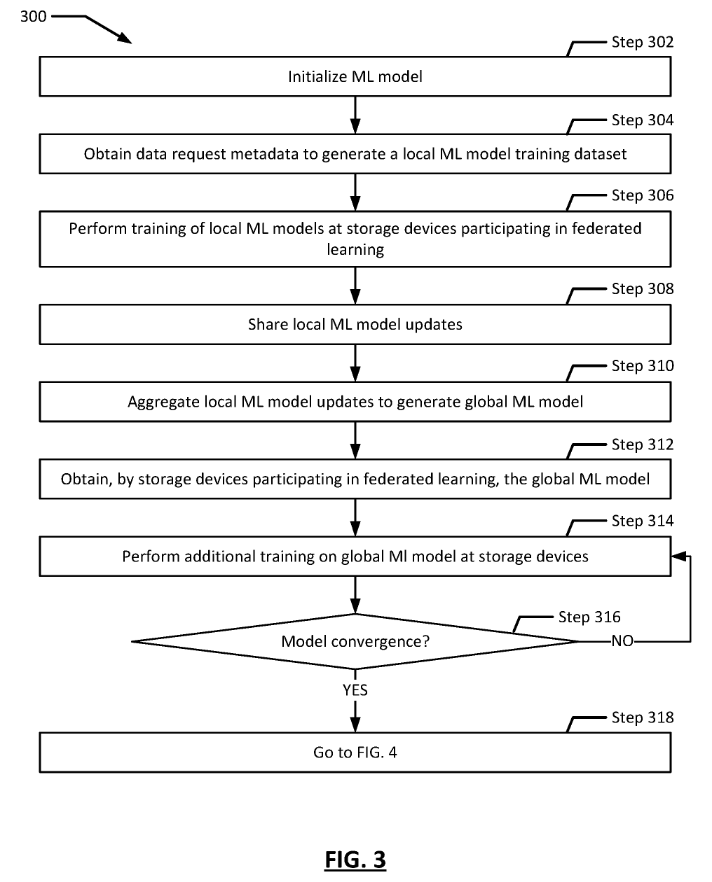

FIG. 3 illustrates an overview of an example method 300 for performing federated training of a ML model for data storage, in accordance with to one or more examples disclosed herein. The method 300 may be performed, at least in part, by one or more storage devices (e.g., the storage device A 106, the storage device N 114 of FIG. 1), any component in such storage devices (e.g., the ML component A 108, the ML component N 116 of FIG. 1), and/or any computing device (e.g., the computing device of FIG. 5) implementing such a storage device and/or ML component.

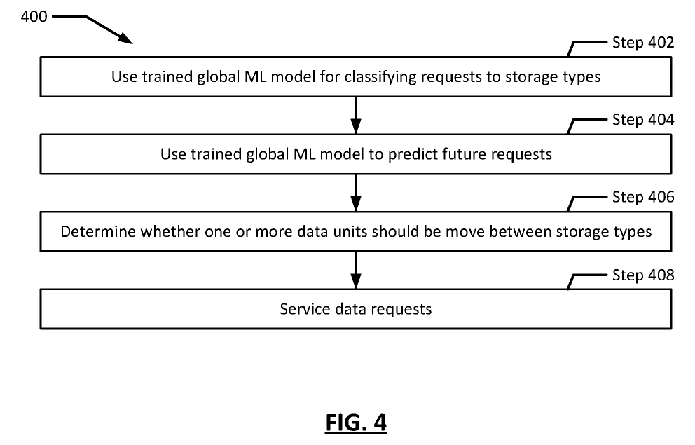

While the various steps in the flowchart shown in FIG. 3 are presented and described sequentially, some or all of the steps may be executed in different orders, some or all of the steps may be combined or omitted, and some or all of the steps may be executed in parallel with other steps of FIG. 3 and/or FIG. 4 (discussed below).

In Step 302, the method 300 includes initializing an ML model. In one or more examples, initializing an ML model includes setting initial values for the parameters of the ML model. Any form of ML model initialization may be used without departing from the scope of examples disclosed herein. As an example, initialization may include setting initial weights or gradient values for an ML model. Initialization of the ML model may be performed prior to the ML model being provided to storage devices that will be training and using an ML model, or each storage device may receive the ML model and perform initialization.

In Step 304, the method 300 includes obtaining data request metadata to generate a training data set for performing local training of an ML model. In one or more examples, the data request metadata may be obtained, for example, by a ML component (e.g., the ML component A 108, the ML component N 116 of FIG. 1) of a storage device. In one or more examples, the data request metadata is obtained from a request metadata data structure (e.g., the request metadata data structure 200 of FIG. 2, the request metadata data structure A110 of FIG. 1, the request metadata data structure N 118 of FIG. 1). The data request metadata obtained to be used as a training dataset may be all or any portion of the request metadata included in a request metadata data structure.

In Step 306, the method 300 includes performing training of local ML models at storage devices participating in federated learning. In one or more examples, the training may be performed, for example, by a ML component (e.g., the ML component A 108, the ML component N 116 of FIG. 1) of a storage device. In one or more examples, each storage device in a data storage environment that is configured to participate in a federated learning system is provided with a copy of an ML model as a local ML model. After such a model is initialized (as in Step 302), and training data is obtained (as in Step 304), the training data may be used as input to the local ML model to perform training of the local ML model. Training may include providing the data request training data to the Local ML model, assessing the output of the model (e.g., how well the model predicts future data requests), and adjusting the model parameters (e.g., weights, gradients, and the like). Training the local ML model may be an iterative process, in which any number of cycles, or iterations, of training are performed. Training may conclude after a certain number of iterations, after a threshold of accuracy of the local ML model is achieved, once a loss function for the local ML model has been minimized to an acceptable level, and the like.

In Step 308, the method 300 includes sharing local ML model updates. In one or more examples, the sharing may be performed, for example, by a ML component (e.g., the ML component A 108, the ML component N 116 of FIG. 1) of a storage device. In one or more examples, each storage device participating in federated learning performs training of a local ML model using local training data obtained by the storage device based on received data requests. In one or more examples, once local ML model training has been completed, the storage device may share the model parameters of the trained local model as local ML model updates. In one or more examples, sharing the local ML model updates includes providing the local ML model updates to each other storage device participating in federated learning, so that each storage device may generate a global ML model. In one or more examples, sharing the local ML model updates includes providing the local ML model updates to a particular device configured to generate a global ML model.

In Step 310, the method 300 includes aggregating local ML model updates to generate a global ML model. Any technique for aggregating ML model parameters may be used without departing from the scope of examples disclosed herein. As an example, local ML model updates received from the various storage devices participating in federated learning may be aggregating by determining the average of the local ML model updates for the various parameters of the ML model to generate the parameters for the global ML model.

In Step 312, the method 300 includes obtaining, by storage devices participating in the federated learning, the global ML model. In one or more examples, the global ML model may be obtained, for example, by a ML component (e.g., the ML component A 108, the ML component N 116 of FIG. 1) of a storage device. As discussed above, the global ML model is generated by aggregating (e.g., averaging) local ML model parameters. In some examples, this aggregation is performed at each storage device after receiving local ML model updates from each of the other storage devices, allowing the storage device to obtain he global ML model by being the entity that performs the aggregation. In other examples, where local ML model updates are shared with a particular device (e.g., a designated one of the storage devices, any other device configured to perform ML model update aggregation), obtaining the global model includes receiving the global ML model from the device that performed the aggregation.

In Step 314, the method 300 includes performing additional training, by the storage devices, of the global ML model. In one or more examples, the additional training may be performed, for example, by a ML component (e.g., the ML component A 108, the ML component N 116 of FIG. 1) of a storage device. In one or more examples, the additional training is performed again using local request data from the request metadata data structure of the storage device.

In Step 316, the method 300 includes making a determination as to whether the global ML model has converged. In one or more examples, model convergence may be determined, for example, by a ML component (e.g., the ML component A 108, the ML component N 116 of FIG. 1) of a storage device. In one or more examples, the additional training of Step 314 is performed until model convergence is achieved. In one or more examples, model convergence is achieved when the global model stops improving (e.g., minimization of the loss function ceases) and/or when an acceptable threshold of model performance is achieved. In one or more examples, if the model has not converged, the method 300 returns to Step 314 for additional training of the global ML model. In one or more examples, if model convergence has been achieved, the method 300 proceeds to Step 318.

In Step 318, the method 300 proceeds to the method 400 shown in FIG. 4 and discussed below.

FIG. 4 illustrates an overview of an example method 400 for using a trained federated learning ML model for data storage, in accordance with to one or more examples disclosed herein. The method 400 may be performed, at least in part, by one or more storage devices (e.g., the storage device A 106, the storage device N 114 of FIG. 1).

While the various steps in the flowchart shown in FIG. 4 are presented and described sequentially, some or all of the steps may be executed in different orders, some or all of the steps may be combined or omitted, and some or all of the steps may be executed in parallel with other steps of FIG. 4 and/or FIG. 3.

In Step 402, the method 400 includes using the trained global ML model (as discussed above in the description of FIG. 3) to classify requests to storage types. In one or more examples, at this stage, predictions of future data requests are used to classify into what storage type data units corresponding to the data requests should be placed. As an example, based at least in part on future predictions, certain data units may be classified to be stored in relatively faster storage, medium speed storage, or relatively slower storage.

In Step 404, the method 400 includes using the trained global ML model to predict future data requests. In one or more examples, the trained global model, which has been trained, at least in part, using the history of data requests and associated information stored in the request metadata data structure of a storage device, begins to be used to predict when future requests for particular data units may be received.

In Step 406, the method 400 includes determining whether one or more data units should be moved between storage types based on predictions from the trained global ML model of future data requests. As an example, an effectiveness algorithm may be executed to determine whether data units should: remain in whatever storage type the data units are currently stored in; be pre-fetched from one storage type to another storage type, or be evicted from one storage type to another storage type. In one or more examples, execution of an effectiveness function determines what data units should be stored in certain storage types. In one or more examples, the effectiveness function is based, at least in part on the projected hit rate of data being kept in each storage types, which may be modified, for example, by one or more cost factors (e.g., expense, carbon emissions, and the like). In one or more examples, if the predicted effectiveness of keeping a data unit in a particular storage type falls below a predicted effectiveness of having the data unit stored in another storage type, the data unit may be moved (e.g., either pre-fetched or evicted) between storage types. In one or more examples, the effectiveness of keeping a data unit in a particular storage type may be continuously re-evaluated over time. As an example, as times approach when a data unit is predicted by the trained global ML model to be part of a received data request, it may become more effective to, for example, move data from a relatively slower and less expensive tier of storage to a faster and more expensive tier of storage, which may, for example, increase response time for data requests when the data requests are received, while lowering data storage expense at other times.

In one or more examples, although not shown in FIG. 4, at this stage, multi-objective goals may be taken into consideration related to where data is stored, and when data may be moved between storage types. In one or more examples, each objective of a set of multi-objective goals for data storage (e.g., expense, performance, data fragmentation, carbon emissions, and the like) may be considered a factor or dimension that is used to determine Pareto optimal states, which is where a state (e.g., where the data is stored) for the data exists that is optimal across one dimension (e.g., energy efficiency), and that no other state exists that is as energy efficient and that is also better in other dimensions of the dimensions being analyzed. In one or more examples, once such Pareto optimal states have been identified, dynamic analysis may be performed to determine the effect of changing the model to optimize for other outcomes as priorities (e.g., of data storage customers, data storage providers, and the like) change over time. As an example, at different times, response time to data requests may be higher priority than other factors, such as cost, or environmental impact, or lower cost sources of power (e.g., solar power) may become available, making it more attractive to store data in faster but higher power use storage types. In one or more examples, once these trade-offs are understood, parameters of the trained global ML model may be adjusted to achieve whatever scenario is most desirable to relevant stakeholders of a data storage environment.

In Step 408, the method 400 includes servicing data requests. In one or more examples, as data requests are received, based on the predictions and classifications of the trained global ML model, and any optimizations made thereto, the data units accessible by a particular storage device are optimally stored in one or more storage types of a data storage environment. In one or more examples, when a request related to a data unit is received, the storage device may determine in which storage type the data unit is currently stored (e.g., using a storage map of the storage device), and the whatever request type included in the data request may be executed using the data unit.

In one or more examples, although not shown in FIG. 4, the above-described processes of training and using the trained global ML model may be performed repeatedly over time. As an example, the local and global ML model may be retrained from time to time, as data request patterns and other factors may change over time. As another example, the trained global ML model may be configured to be run based on a context window, which may change over time (e.g., based on information learned over time about the seasonality of receipt of data requests). As execution of the trained global ML model results in predictions of when data requests may be received, and possible movement of data between storage types, different context window sizes (e.g., hourly, daily, and the like) may be appropriate for different data storage scenarios.

FIG. 5 illustrates a block diagram of a computing device, in accordance with one or more examples of this disclosure. As discussed above, examples described herein may be implemented using computing devices, and the computing device 500 shown in FIG. 5 may be such a computing device. For example, all or any portion of the components shown in FIG. 1 (computing devices 100, 102, 104, storage devices 106, 114) may be implemented, at least in part using the computing device 500, and may include all or any portion of the components of the computing device 500 shown in FIG. 5 and described below. Additionally, all or any portion of the method shown in FIG. 3 and/or FIG. 4 may be performed using one or more computing devices, such as the computing device 500.

In one or more examples, a computing device (e.g., the computing device 500) is any device, portion of a device, or any set of devices capable of electronically processing instructions and may include, but is not limited to, any of the following: one or more processors (e.g. components that include circuitry) (e.g., the processor 502), memory (e.g., random access memory (RAM)) (not shown), input and output device(s) (e.g., the non-persistent storage 506), non-volatile storage hardware (e.g., solid-state drives (SSDs), persistent memory (Pmem) devices, hard disk drives (HDDs) (not shown)), one or more physical interfaces (e.g., network ports, storage ports) (e.g., the persistent storage 506), any number of other hardware components (not shown), and/or any combination thereof. As used herein, a processor may be any component that can be configured to execute operations, processes, threads, and the like. Examples of a processor include, but are not limited to, central processing units (CPUs), multi-core CPUs, application-specific integrated circuits (ASICs), accelerators (e.g., graphics processing units (GPUs)), and field programmable gate arrays (FPGAs). Other examples of processor types may be included in the computing device 500 without departing from the scope of examples disclosed herein. In some examples, a computing device (e.g., the computing device 500) may include any number of heterogeneous processors.

The computing device 500 may include a communication interface 512 (e.g., Bluetooth interface, infrared interface, network interface, optical interface, any other type of communication interface), input devices 510, output devices 508, and numerous other elements (not shown) and functionalities. Each of these components is described below.

In one or more examples, the computer processor(s) 502 may be an integrated circuit for processing instructions. For example, the computer processor(s) may be one or more cores or micro-cores of a processor. The processor 502 may be a general-purpose processor configured to execute program code included in software executing on the computing device 500. The processor 502 may be a special purpose processor where certain instructions are incorporated into the processor design. The processor 502 may be an application specific integrated circuit (ASIC), a graphics processing unit (GPU), a data processing unit (DPU), a tensor processing units (TPU), an associative processing unit (APU), a vision processing units (VPU), a quantum processing unit (QPU), and/or various other processing units that use special purpose hardware (e.g., field programmable gate arrays (FPGAs), System-on-a-Chips (SOCs), digital signal processors (DSPs)). Although only one processor 502 is shown in FIG. 5, the computing device 500 may include any number of processors without departing from the scope of examples disclosed herein.

The computing device 500 may also include one or more input devices 510, such as a touchscreen, keyboard, mouse, microphone, touchpad, electronic pen, motion sensor, or any other type of input device. The input devices 510 may allow a user to interact with the computing device 500. In one or more examples, the computing device 500 may include one or more output devices 508, such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) 502, non-persistent storage 504, and persistent storage 506. Many different types of computing devices exist, and the aforementioned input and output device(s) may take other forms. In some instances, multimodal systems can allow a user to provide multiple types of input/output to communicate with the computing device 500.

Further, the communication interface 512 may facilitate connecting the computing device 500 to a network (not shown) (e.g., a local area network (LAN), a wide area network (WAN) such as the Internet, mobile network, or any other type of network) and/or to another device, such as another computing device. The communication interface 512 may perform or facilitate receipt and/or transmission of wired or wireless communications using wired and/or wireless transceivers of any type and/or technology. Examples include, but are not limited to, those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 512 may also include one or more Global Navigation Satellite System (GNSS) receivers or transceivers that are used to determine a location of the computing device 500 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The term computer-readable medium includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, and the like may be passed, forwarded, or transmitted via any suitable means including memory sharing, message passing, token passing, network transmission, or the like.

All or any portion of the components of the computing device 500 may be implemented in circuitry. For example, the components can include and/or can be implemented using electronic circuits or other electronic hardware, which can include one or more programmable electronic circuits (e.g., microprocessors, GPUs, DSPs, FPGAs, CPUs, CAMs, and/or other suitable electronic circuits), and/or can include and/or be implemented using computer software, firmware, or any combination thereof, to perform the various operations described herein. In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

In the above description, numerous details are set forth as examples described herein. It will be understood by those skilled in the art (who also have the benefit of this disclosure) that one or more examples described herein may be practiced without these specific details, and that numerous variations or modifications may be possible without departing from the scope of the examples described herein. Certain details known to those of ordinary skill in the art may be omitted to avoid obscuring the description.

Specific details are provided in the description above to provide a thorough understanding of the aspects and examples provided herein. However, it will be understood by one of ordinary skill in the art that the aspects and examples may be practiced without these specific details. For clarity of explanation, in some instances the present technology may be presented as including functional blocks that may include devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects of examples disclosed herein.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not included in a drawing. A process may correspond to a method, a function, a procedure, a subroutine, a subprogram, and the like. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, and the like. Examples of computer-readable media that may be used to store instructions, information used, and/or information created during methods according to described examples include magnetic or optical disks, flash memory, USB devices provided with non-volatile memory, networked storage devices, and so on.

In the above description of the figures, any component described with regard to a figure, in various examples described herein, may be equivalent to one or more same or similarly named and/or numbered components described with regard to any other figure. For brevity, descriptions of these components may not be repeated with regard to each figure. Thus, each and every example of the components of each figure is incorporated by reference and assumed to be optionally present within every other figure having one or more same or similarly named and/or numbered components. Additionally, in accordance with various examples described herein, any description of the components of a figure is to be interpreted as an optional example, which may be implemented in addition to, in conjunction with, or in place of the examples described with regard to a corresponding one or more same or similarly named and/or numbered component in any other figure.

Throughout the application, ordinal numbers (e.g., first, second, third) may be used as an adjective for an element (i.e., any noun in the application). The use of ordinal numbers is not to imply or create any particular ordering of the elements, nor to limit any element to being only a single element unless expressly disclosed, such as by the use of the terms "before", "after", "single", and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While examples discussed herein have been described with respect to a limited number of examples, those skilled in the art, having the benefit of this disclosure, will appreciate that other examples can be devised which do not depart from the scope of examples as disclosed herein. Accordingly, the scope of examples described herein should be limited only by the attached claims.

What is claimed is:

1. An apparatus, comprising:
one or more processors; and
one or more non-transitory computer readable media storing instructions which, when executed by the one or more processors, cause the one or more processors to:
obtain data request metadata, corresponding to a plurality of data requests received at a storage device, to generate a local training dataset;
perform training of a local machine learning (ML) model at the storage device, wherein the training comprises ML model training for predicting future data accesses and classifying data to be stored in at least one of a plurality of storage types accessible by the storage device;
share local ML model updates based on the training with at least one other device;
obtain a global ML model that incorporates the local ML model updates and a plurality of ML model updates from other storage devices;
perform additional training using the global ML model until the global ML model converges as a trained global ML model;
execute the trained global ML model at the storage device to determine one or more of the plurality of storage types in which to store data units and to predict future data requests; and
store a data unit in one or more of the plurality of storage types based on an output of the trained global ML model.

2. The apparatus of claim 1, wherein the data request metadata for each of the plurality of data requests comprises a request type, an identifier identifying a computing device as a source of the data request; and a timestamp indicating a time of receipt of the data request.

3. The apparatus of claim 1, wherein execution of the instructions by the one or more processors further causes the one or more processors to:
share the local ML model updates by sharing the local ML model updates with each of a plurality of other storage devices configured to participate in federated learning, and
obtain the global ML model by generating the global ML model at the storage device.

4. The apparatus of claim 1, wherein execution of the instructions by the one or more processors further causes the one or more processors to:
share the local ML model updates by sharing the local ML model updates with an ML model aggregation device configured to generate the global ML model, and
obtain the global ML model by receiving, by the storage device, the global ML model from the ML model from the ML model aggregation device.

5. The apparatus of claim 1, wherein each data unit of the data units comprises a block of data, a data file, or a data object.

6. The apparatus of claim 1, wherein the trained global ML model comprises one of a transformer model or a recurrent neural network.

7. The apparatus of claim 1, wherein:
the plurality of storage types each comprise different characteristics, and
the different characteristics comprise different data access response times and different costs associated with data storage.

8. The apparatus of claim 1, wherein execution of the instructions by the one or more processors further causes the one or more processors to:
move the data unit, after storing the data unit, from one storage type of the plurality of storage types to another storage type of the plurality of storage types based on an output of the trained global ML model.

9. The apparatus of claim 1, wherein execution of the instructions by the one or more processors further causes the one or more processors to:
adjust one or more model parameters of the trained global ML model based at least in part on a determination of a Pareto optimal data storage state of the data unit in consideration of a plurality of data storage factors.

10. A computer-implemented method, comprising:
obtaining data request metadata, corresponding to a plurality of data requests received at a storage device, to generate a local training dataset;
performing training of a local machine learning (ML) model at the storage device using the local training dataset, wherein the training comprises ML model training for predicting future data accesses and classifying data to be stored in at least one of a plurality of storage types accessible by the storage device;
sharing local ML model updates based on the training with at least one other device;
obtaining a global ML model that incorporates the local ML model updates and a plurality of ML model updates from other storage devices;
performing additional training using the global ML model until the global ML model converges as a trained global ML model;
executing the trained global ML model at the storage device to determine one or more of the plurality of storage types in which to store data units and to predict future data requests; and
storing a data unit in one or more of the plurality of storage types based on an output of the trained global ML model.

11. The computer-implemented method of claim 10, wherein the data request metadata for each of the plurality of data requests comprises a request type, an identifier identifying a computing device as a source of the data request; and a timestamp indicating a time of receipt of the data request.

12. The computer-implemented method of claim 10, wherein:
the sharing of the local ML model updates comprises sharing the local ML model updates with each of a plurality of other storage devices configured to participate in federated learning, and
the obtaining of the global ML model comprises generating the global ML model at the storage device.

13. The computer-implemented method of claim 10, wherein:
the sharing of the local ML model updates comprises sharing the local ML model updates with an ML model aggregation device configured to generate the global ML model, and
the obtaining of the global ML model comprises receiving, by the storage device, the global ML model from the ML model from the ML model aggregation device.

14. The computer-implemented method of claim 10, wherein each data unit of the data units comprises a block of data, a data file, or a data object.

15. The computer-implemented method of claim 10, wherein the trained global ML model comprises one of a transformer model or a recurrent neural network.

16. The computer-implemented method of claim 10, wherein:
the plurality of storage types each comprise different characteristics, and
the different characteristics comprise different data access response times and different costs associated with data storage.

17. The computer-implemented method of claim 10, further comprising:
moving the data unit, after storing the data unit, from one storage type of the plurality of storage types to another storage type of the plurality of storage types based on an output of the trained global ML model.

18. The computer-implemented method of claim 10, further comprising:
adjusting one or more model parameters of the trained global ML model based at least in part on a determination of a Pareto optimal data storage state of the data unit in consideration of a plurality of data storage factors.

19. A non-transitory computer-readable medium storing programming for execution by one or more processors, the programming comprising instructions to:
obtain data request metadata, corresponding to a plurality of data requests received at a storage device, to generate a local training dataset;
performing training of a local machine learning (ML) model at the storage device, wherein the training comprises ML model training for predicting future data accesses and classifying data to be stored in at least one of a plurality of storage types accessible by the storage device;
share local ML model updates based on the training with at least one other device;
obtain a global ML model that incorporates the local ML model updates and a plurality of ML model updates from other storage devices;
perform additional training using the global ML model until the global ML model converges as a trained global ML model;
execute the trained global ML model at the storage device to determine one or more of the plurality of storage types in which to store data units and to predict future data requests; and
store a data unit in one or more of the plurality of storage types based on an output of the trained global ML model.

20. The non-transitory computer-readable medium of claim 19, wherein:
to share the local ML model updates, the programming includes further instructions to share the local ML model updates with each of a plurality of other storage devices configured to participate in federated learning, and
to obtain the global ML model, the programming comprises further instructions to generate the global ML model at the storage device.
